(19) United States
(12) Patent Application Publication
(10) Pub. No.: US 2005/0005028 A1
(43) Pub. Date: Jan. 6, 2005

(54) Automated image markup system and method

(76) Inventor: Jong Huang, Bellevue, WA (US)

Correspondence Address: SHOOK, HARDY & BACON L.L.P., 2555 GRAND BOULEVARD, KANSAS CITY, MO, 64108-2613, US

(21) Appl. No.: 10/609,388

(22) Filed: Jul. 1, 2003

(51) Int. Cl. G06F 15/16

(52) U.S. Cl. 709/247; 709/219

(57) ABSTRACT

A method and system are provided for storing and rendering images for use on a web page. The system includes a media server including a content store for storing an original version of an image and a media handler including a rendering component for rendering a requested version of the image from the original version. The system additionally includes a web server for seeking the requested image upon receiving a user request for the image. The web server includes a web server media handler for seeking the requested image from the media server and for returning the requested image to the user. The media server may also include a content management system for notifying the web server if the original versions of the images are updated.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention relates to techniques for displaying images on web pages, and in particular to techniques for rendering and displaying requested versions of images on a web page.

### BACKGROUND OF THE INVENTION

Images greatly enhance presentation of news stories and products for sale over the Internet. Different versions of the same image are often required depending upon the type of presentation desired. News web sites such as MSNBC's web site contain images of different sizes and renditions. For example, a figure used in a news story may contain a drop shadow and a credit line. An entry point for a slide show may include a small thumbnail image. Buttons for video may also use smaller images. Vendor websites may require several versions of the same image in order to display products individually in a high-resolution version and in display groups in lower resolution versions.

Images generally require a large amount of storage space. Current procedures require generation and storage of images of various sizes and renditions in anticipation of all possible usages. It is largely a manual process since media producers don't know how the image is going to be used. The process is more time consuming then necessary since each image may not ultimately be requested in every stored version. Alternatively, we can rely on the browser to scale the images to different sizes by setting the width and height of the images using HTML code. With this approach, however, the file size stays the same regardless of the image size and this arrangement consumes excessive space and bandwidth.

As a practical example, in a slide show, every entry button requires a thumbnail image. Furthermore, each image in a slide show needs to have three sizes, one for each target device resolution (640×480, 800×600, and 1024×768). The process of generating and storing each version consumes both time and storage space. The existence of multiple renditions of the same images also complicates tracking of the image usage and life span.

Another process used in retrieving web pages, allows the retrieval of one image file, but allows it to be displayed in different display formats having different sizes. Accordingly, the downloading time to a user's browser is the same regardless of the display format of the image, since the size of the image file remains the same.

For example, when a browser sees the tag in a hypertext markup language (HTML) page such as <img src=http://www.msnbc.com/i/12345.jpgwidth=140 height=60/>, the browser will request the image from the URL from the web server. The browser will obtain the image as stored and will cause the image to be displayed with width=140 and height =60 pixels. If the tag is <img src=http://www.msnbc.com/i/12345.1 pg width=70 height=30/>, however, the same image will be displayed 70 pixels wide and 30 pixels high. The image will be one quarter of the size of the previous image. The browser has the capability to scale the picture according to the width and height attributes in the <img>tag. However, the browser again will obtain the image and display it in the specified size. In this example, the HTML page will load in exactly the same amount of time since the two images, though displayed in different sizes, actually have the same file size. Hence there is no saving in bandwidth and download time.

Accordingly, a new solution is needed for storing and rendering images that minimizes the amount of storage space and the amount of downloading time required. Furthermore, a solution is needed that will allow different versions of images to be produced upon demand to avoid wasteful procedures.

### SUMMARY OF THE INVENTION

In one aspect, the invention includes a system for transmitting a requested image to a user. The system includes a media server including a content store for storing an original version of an image. The media server additionally includes a media handler having a rendering component for rendering a requested version of the image from the original version. The system also includes a web server for seeking the requested image. The web server includes a web server media handler for seeking the requested image from the media server and for returning the requested image to the user.

In an additional aspect, the invention includes a media server system for transmitting a requested image to a web server. The media server includes a content store for storing an original version of an image. The media server additionally includes a media handler including an image retrieval component for retrieving the original version of the image, an image rendering component for rendering a requested version of the image based on the original version, and an image transmission component for transmitting the requested version of the image.

In a further aspect, the invention includes a method for providing a requested image to a user. The method includes storing an original image in a content store of a media server. The method additionally includes rendering a requested version of the original image using a media handler and returning the requested version.

In yet a further aspect, a method for transmitting a requested image to a user upon receiving a user request for the image is provided. The method includes searching for the requested image in a web server image store and requesting the requested image from a media server if the requested image is not in the web server image store. The method additionally includes searching a media server cache for the requested image if the requested image is not in the web server image store and retrieving an original version of the requested image from a media server content store if the requested image is not in the media server cache. The method additionally includes rendering the requested version of the image from the original version if the requested version is not in the media server cache and returning the requested image version.

### BRIEF DESCRIPTION OF THE DRAWINGS

The present invention is described in detail below with reference to the attached drawing figures, wherein:

FIG. 1 is a block diagram showing a system of the invention;

FIG. 2 is a block diagram of a suitable computing system environment for use in implementing the present invention;

FIG. 3 is a block diagram illustrating a configuration of a media server in accordance with an embodiment of the invention;

FIG. 4 is a block diagram illustrating components of a web server in accordance with an embodiment of the invention;

FIG. 5 is a flow chart illustrating a method for returning a requested image in accordance with an embodiment of the invention; and

FIGS. 6(A), 6(B), and 6(C) illustrate examples of three different image rendering styles.

### DETAILED DESCRIPTION OF THE INVENTION

The invention relates to a system for storing and producing images for display upon receipt of a user request. The invention is an automatic image markup system for efficiently displaying images of different sizes and renditions on web pages.

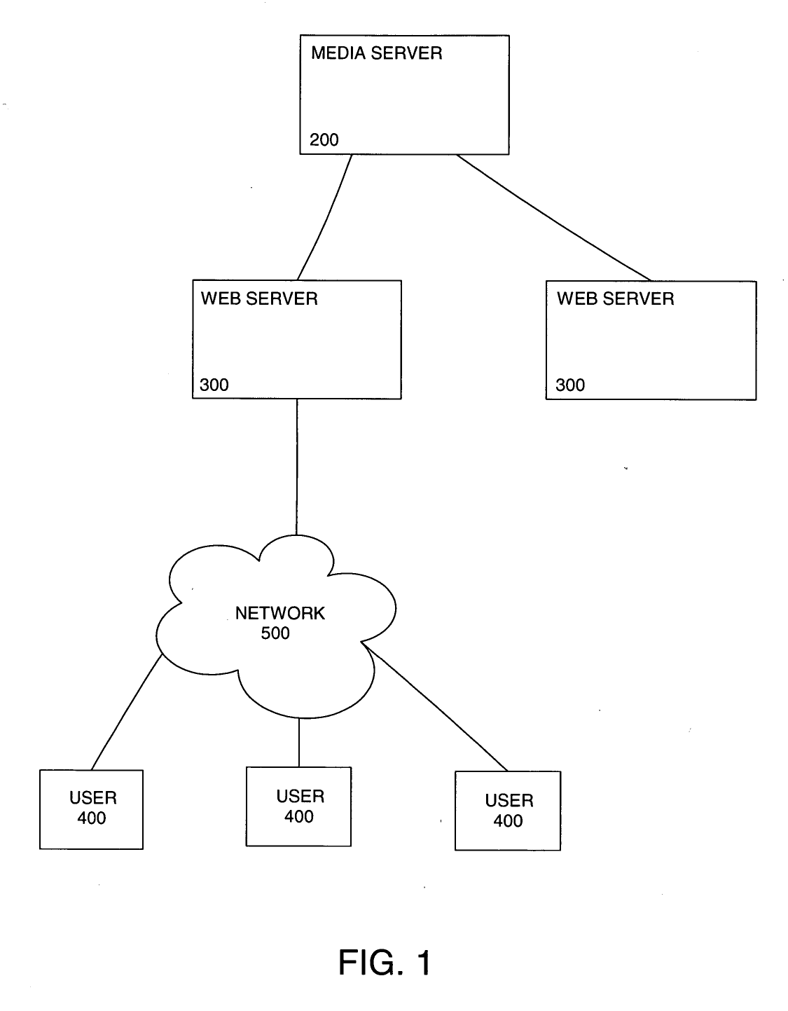

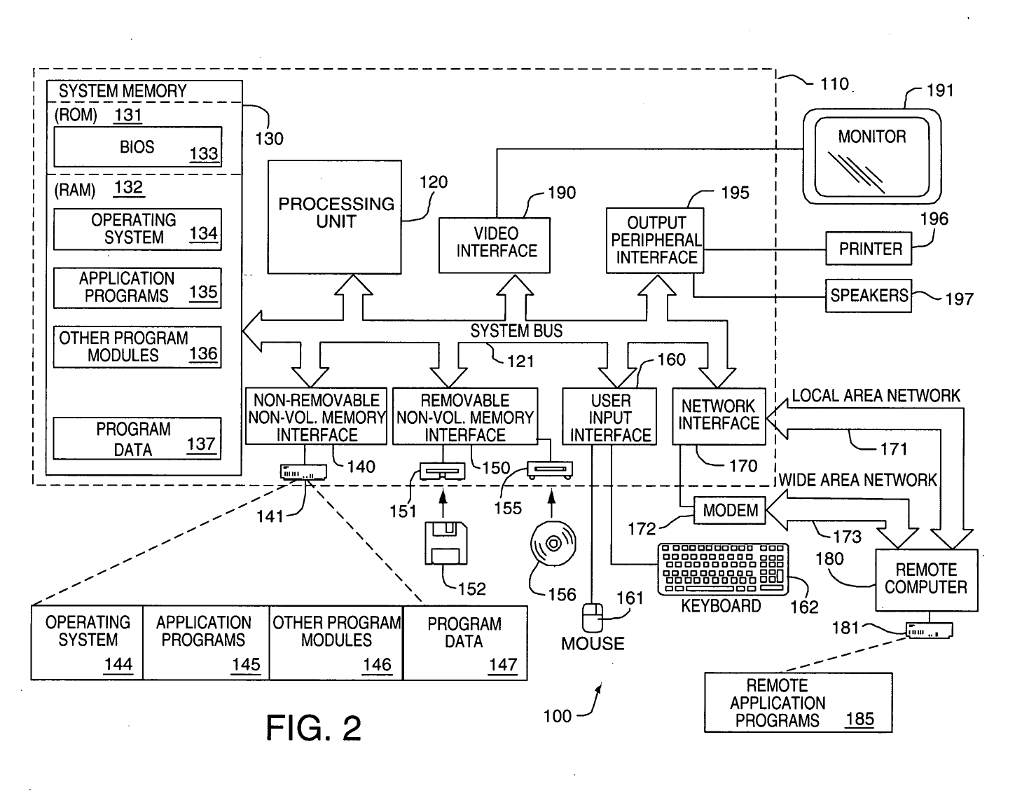

FIG. 1 illustrates a system for returning images upon receiving a user request. Users 400 communicate over a network 500 with one or more web servers 300. Each web server 300 communicates with a media server 200. The web servers 300 may communicate with the media server 200 over the network 500 or through an alternative connection. One media server 200 may provide services to a plurality of web servers 300. The network 500 may be the Internet or any other type of network as described below with reference to FIG. 2. The media server 200 may additionally communicate with the web servers 300 over a network. The media server 200, web servers 300, and users 400 are implemented in computerized environments as described below with reference to FIG. 2.

FIG. 2 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention may operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

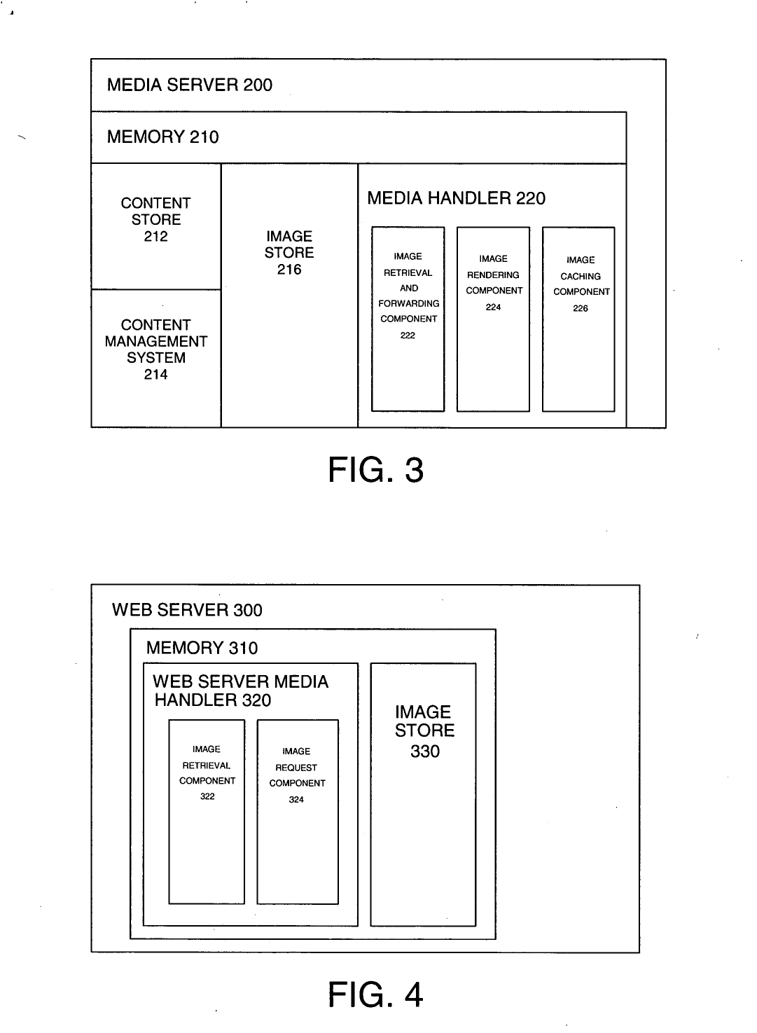

FIG. 3 illustrates components of the media server 200 in accordance with an embodiment of the invention. The media server 200 is implemented in a computerized environment as described above in reference to FIG. 2 and may include a memory 210 storing a content store 212, a content management system 214, an image store 216, and a media handler 220. Although the memory 210 is shown as a generalized memory, the aforementioned components may be stored in different areas of the computerized environment. In particular, the image store 216 and the content store 212 may be stored in separate storage facilities. The content management system 214 stores only one original version of every image in the content store 212. The content store 212 stores the original version in the largest size and highest resolution anticipated in accordance with an anticipated usage scenario.

The media handler 220 may include an image retrieval and forwarding component 222, an image rendering component 224, and an image caching component 226. Accordingly, when a request is received for a particular image, the image rendering component 224 renders the image according to the request on demand. After the image rendering component 224 renders the image, the image caching component 226 may cache the image in the image store 216 since the newly rendered image may likely be requested again. Accordingly, the image rendering component 224 renders images only if the image retrieval component 222 does not locate a cached image in the image store 216.

FIG. 4 illustrates an embodiment of the web server 300. The web server 300 may include a memory 310 storing a web server media handler 320 including an image retrieval component 322 and an image request component 324. The memory 310 may also include an image store 330. The web server 300 will typically receive an image request from the user 400 and may pass the image request to the media server 200 if required. This process will be further described below.

The users 400 also operate in a computerized environment substantially as described above with reference to FIG. 2. Typically the users 400 will be implementing a browser and selected desired images through the browser.

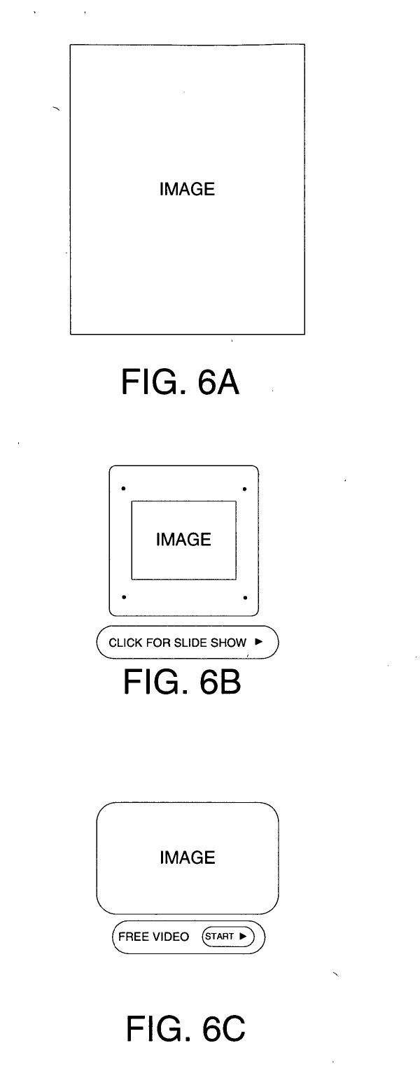

In an embodiment of the system of the invention, rendering options are encoded as part of the image file name in order to ensure that the actual image file size can be changed upon demand. Accordingly, the image rendering component 224 will render the requested image based on the file name of the requested image. In an exemplary embodiment, the image file name is of the form “Name, w, h, o.ext”. “Name” is the name of the image file. The “w” represents the maximum width in pixels for the image. If w is represented by a zero, then the width will be scaled proportionally according to the height. The “h” represents the maximum height in pixels for the image. If “h” is equal to zero, the height will be scaled proportionally according to the width. The “o” is the name of the rendering style for the image. The rendering style is used when both w and h are represented by zeros. Examples of rendering styles are shown in FIGS. 6(A)-6(C). FIG. 6(A) shows a “photoMain” rendering style. FIG. 6(B) shows a “slideTease” rendering style and FIG. 6(C) shows a “videoTease” rendering style. “Ext” is the extension of the file, such as joint photographic experts group (jpg) or graphics interchange format (gif).

For instance, if a user request is in the form “Test 200,0.jpg”, the request seeks an image based on an original image called “testjpg” that has the width of no more than 200 pixels. Since the requested height is “0”, the image height is scaled proportionally from the width. A request in the form “Test, 0,0,photoMainjpg” seeks an image based on the original image “test.jpg” that will format the image into the main photo format (including drop shadow, the credit, and proper width and height for main photo) as depicted in FIG. 6A.

If the media handler 220 receives the request for “Test, 200,0.jpg”, it will seek the appropriate version of the file “testjpg”. For example, if the image retrieval and forwarding component 222 determines that the image store 216 does not contain the requested image file “test, 200,0jpg”, it will retrieve the original image file “Testjpg” from the content store 212. The image rendering component 224 will decide from the requested file name that it needs to generate an image with a width of not more than 200 pixels from the original high resolution version of the image called “testjpg”.

As set forth above, a media handler 220 is provided in the media server 200 and a web server media handler 320 is provided in the web server 300. The web server media handler 320 handles all requests for images by intercepting the requests before the Internet information server (IIS) can detect them. The media handler 320 may be NET HTTP handler that takes a request for an image and finds the image on demand. In a preferred embodiment, a web server media handler 320 is installed on each web server 300. These web server media handlers 320 service requests coming from the users 400. The request for images follows the four-part file name specification illustrated in the previous section. The web server media handler 320 on the web server 300 will first try to find the same named image file on its local image store 330. If the image retrieval component 322 finds the image, it retrieves the image and returns it to the user 400. If the image retrieval component 322 does not find the image, the image has not been rendered, and the web server media handler 320 will forward the request using the image request component 324 to the media server 200.

When web server media handler 320 cannot find the image for the user request 400, it in turn forwards the same request to the media handler 220. In this case, the web server 300 is acting as though it were the user 400 to the media server 200. The rendered image will return as a result of the HTTP request forwarded to the media server 200 from the web server 300. Once the web server media handler 320 receives the image bits as a result of the HTTP request from the media handler 220, it caches the image for later use in the image cache 330 and then returns the same image bits as result of the original HTTP request sent by the user 400.

The media handler 220 on the media server 200 looks at the file name described above to determine rendering. As set forth above, the width and height components are optional. If the user 400 wants the original image, the user 400 can request the image by name only. Generally, an image request will not specify both width and height because every image has aspect ratio. Accordingly, the media handler 220 is capable of determining the correct dimensions based on the aspect ratio of the image. If the image request specifies both width and height, the media handler 220 will view the width and height specifications as maximums and will maintain the proportions required by the aspect ratio. The media handler 220 will only generate a new size using the image rendering component 224 if the size does not already exist in the image cache 216.

Accordingly, the media handler 220 differs from the web server media handler 320 in that the media handler 220 on the media server 200 will render the image requested if the requested image does not yet exist. The rendering of images occurs only on the media server 200, which maintains the content store for original images only. Original images are not copied to all of the web servers 300, thus simplifying content replication and saving valuable storage space.

Since the entire image rendering is based on the original images, the rendered images become obsolete when the original image is updated. Upon updating, the content management system 214 copies the updated original images to the content store 212. The content management system 214 may initiate publication of a change notification to inform the web server 300 that any cached images in the image store 330 should be dropped. The media server 200 will clear the cached images that have been updated from the image store 216.

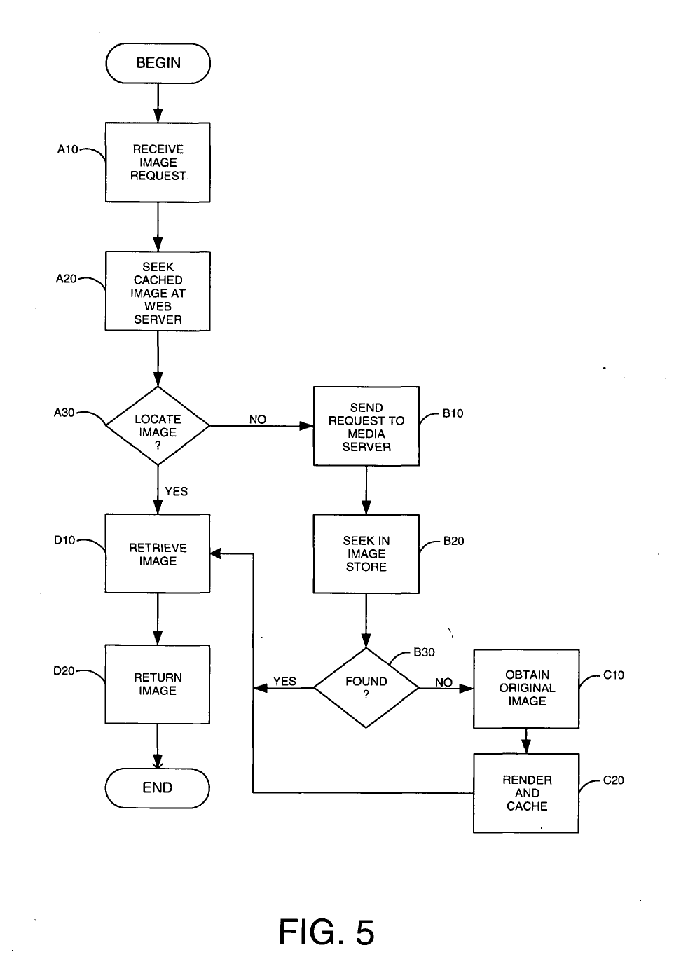

FIG. 5 illustrates a method for retrieving and returning an image in accordance with a user request. In step A10, the web server 300 receives a request from the user 400. A request for an image arrives at the web server 300. The web server 300 invokes the web server media handler 320 to process the URL because the web server media handler 320 is a NET HTTP handler registered to handle requests for files with .jpg and .gif extensions.

In step A20, the web server media handler 320 checks the web server image store 330 using the image retrieval component 322. The media handler 320 on the web server 300 will look at its file store for the image as specified by the URL. If the correct version of the image is located in A30 in the image store 330, the media handler 320 retrieves the image in step D10 and returns the image to the user in step D20.

If the correct version of the image is not located in A30, the media handler 320 uses the image request component 324 to request the image from the media server 200 in step B10. In step B20, the media handler 220 uses its image retrieval and forwarding component 222 to determine if the requested version of the image exists in the image store 216. The media handler 220 on the media server 200 will look at its image store 216 for the image. If the correct version exists, the media handler 220 passes the image to the web server 300 to perform steps D10 and D20 described above.

If the correct image version is not found in step B30, the media handler 220 seeks the original high-resolution image from the content store 212 in step C10. In step C20, the media handler 220 uses its image rendering component 224 to render the requested version of the image and cache the image in the image store 216. The media handler 220 on the media server 200 renders the image according to the URL. The rendered image will be saved into the image store 216 for cached images. The media handler 220 then returns the image to the web server 300 to perform steps D10 and D20 described above.

The system of the invention provides a more efficient way of generating different renditions of images on demand. Rendering and delivering high quality images in an efficient way is an important task for all web sites and can be applied to all web sites with images.

In the above described image retrieval scenario, images are rendered only when requested. Accordingly, the system is not required to anticipate the usage and pre-generate images of different sizes and rendition and replicate these images to all the web servers. The goal is to store only one copy of every image in the largest size according to an anticipated usage scenario. When a request arrives for a particular image, the system will render the image on demand in accordance with the request. The omission of the universal rendering and storage activity results in tremendous saving of storage space, bandwidth, and ease of image replication and maintenance. At any given time, the system can delete all images on the web servers. The images will be re-generated when requests come in.

The present invention has been described in relation to particular embodiments, which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and with the scope of the claims.

1. A system for transmitting a requested image to a user, the system comprising:
a media server comprising a content store for storing an original version of an image and a media handler including a rendering component for rendering a requested version of the image from the original version; and
a web server for seeking the requested image, the web server comprising a web server media handler for seeking the requested image from the media server and for returning the requested image to the user.

2. The system of claim 1, wherein the media handler comprises an image store and an image caching component for caching rendered images in the image store.

3. The system of claim 2, wherein the media handler comprises an image retrieval and forwarding component for retrieving rendered images from the image store and forwarding rendered images to the web server.

4. The system of claim 1, wherein the web server comprises an image store for storing rendered images.

5. The system of claim 1, wherein the media server comprises an image store.

6. The system of claim 1, wherein the media server comprises a content management system for controlling the content store.

7. The system of claim 6, wherein the content management system includes a notification mechanism for providing image updates to the web server.

8. The system of claim 1, wherein the media handler renders an image having a smaller file size than an original file size of the original version.

9. A media server system for transmitting a requested image to a web server, the media server system comprising:
a content store for storing an original version of an image; and
a media handler including an image retrieval component for retrieving the original version of the image from the content store, an image rendering component for rendering a requested version of the image based on the original version, and an image transmission component for transmitting the requested version of the image.

10. The system of claim 9, wherein the rendered image is stored in an image file smaller than an original file for storing the original version of image.

11. The system of claim 9, further comprising an image store for caching rendered images.

12. The system of claim 11, wherein the media handler comprises an image caching component for caching rendered images in the image store.

13. The system of claim 11, wherein the media handler comprises an image retrieval and forwarding component for retrieving rendered images from the image store and forwarding rendered images to a web server.

14. The system of claim 9, wherein the media server comprises a content management system for controlling the content store.

15. The system of claim 14, wherein the content management system includes a notification mechanism for providing image updates to a web server.

16. A method for providing a requested image to a user, the method comprising:
storing an original image in a content store of a media server;
rendering a requested version of the original image using a media handler; and
returning the requested version.

17. The method of claim 16, wherein rendering a requested version comprises rendering the requested version in a smaller file size than a file size of the original image.

18. The method of claim 16, further comprising sending the rendered image to an image store in the media server.

19. The method of claim 18, further comprising retrieving the rendered image from the image store and forwarding rendered images to a web server.

20. The method of claim 16, further comprising implementing a content management system for controlling the content store.

21. The method of claim 16, further comprising implementing the content management system to notify a web server of image changes.

22. The method of claim 16, wherein rendering the image version comprises determining an image size based on a file name.

23. A computer-readable medium having computer-executable instructions for performing the method recited in claim 16.

24. A method for transmitting a requested image to a user upon receiving a user request for the image at a web server, the method comprising:
searching for the requested image in a web server image store;
requesting the requested image from a media server if the requested image is not in the web server image store;
searching a media server cache for the requested image if the requested image is not in the web server image store;
retrieving an original version of the requested image from a media center content store if the requested image is not in the media server cache;
rendering the requested version of the image from the original version; and
returning the requested image.

25. The method of claim 24, further comprising implementing a content management system to notify the web server of changes to original images in the content store.

26. The method of claim 24, wherein rendering the requested version comprises creating an image file having a smaller file size than a file size of the original version.

27. The method of claim 24, further comprising selecting an image rendering size based on an image file name.

28. A computer-readable medium having computer-executable instructions for performing the method recited in claim 24.

29. A memory for storing data accessible to a requester, the memory comprising:
a content management system for storing an original image version in a content store;
an image rendering component for rendering a requested version of an image from the original image version;
an image caching component for caching the rendered image in an image store; and
an image retrieval and forwarding component for forwarding the rendered image to the requestor.
